(19) United States
(12) Patent Application Publication
(10) Pub. No.: US 2021/0405369 A1
(43) Pub. Date: Dec. 30, 2021

(54) SYSTEM AND METHODS OF HOLOGRAPHIC EXTENDED REALITY PLATFORM TO LAYER VIRTUAL OBJECTS IN REAL OR AUGMENTED ENVIRONMENTS

(71) Applicant: Raymond King, Los Angeles, CA (US)

(72) Inventor: Raymond King, Los Angeles, CA (US)

(21) Appl. No.: 16/917,764

(22) Filed: Jun. 30, 2020

(51) Int. Cl. G02B 27/01; G06F 3/01; G06T 19/00

(52) U.S. Cl. CPC G02B 27/0172; G06F 3/011; G02B 2027/0187; G02B 2027/0174; G02B 2027/0138; G06T 19/006

(57) ABSTRACT

The embodiments disclose a method including creating an XR holographic platform configured for combining VR, AR and MR, choosing the way a user interacts with the XR holographic platform, including using reality headsets to replicate a real environment to create an immersive experience and a computer simulated reality, creating at least one user open hologram and at least one user work product holographic screen, generating computer overlays for adding to real world environments using a user selected type of device from a group including a cell phone, glasses, headsets, and others, and using holographic cameras, projectors and recorders for merging of real and virtual worlds, physical and digital objects configured to co-exist and interact in real time.

### TECHNICAL FIELD

The disclosed technology relates generally to how users see, create, layer and share virtual holograms intermixed with the real world.

### BACKGROUND

Today there is growth in three immersive technologies, Virtual Reality (VR) Augmented Reality (AR) and Mixed Reality (MR). Each is limited, has drawbacks and exists within its own realm. With VR, users wear headsets giving them a fully immersive experience, however it totally cuts the user off from the real world, which can place the user in danger. AR overlays digital information on the real world. You can see Virtual Objects (VOB) like text, characters, avatars, etc., but can't interact with them. Mixed Reality (MR) allows you to interact real time with VOBs, but as with VR, you need to wear a headset. It also takes a lot more processing power to enable a MR experience than a VR or AR one. What is needed is a system that combines all of the above, provides freedom of user movement, generates realistic virtual objects with depth of field, and is accessible through a variety of devices.

### SUMMARY OF THE INVENTION

The invention is a system and methods of an Extended Reality (XR) holographic platform configured for combining Virtual Reality (VR), Augmented Reality (VR) and Mixed Reality (MR) to create an immersive experience or a computer simulated reality. The platform is configured to offer the user options in how the user interacts with the XR holographic platform. Input to the XR holographic platform includes but is not limited to XR gloves, eye movements, touches, game controllers, sound activation, keyboards, real or virtual, and hand gestures.

The XR holographic platform is configured for creating at least one user open hologram and at least one user work product holographic screen. The XR holographic platform is configured for generating computer overlays for adding to real world environments using, including but not limited to a user selected type of device from a group including a cell phone, glasses, headset and others. The XR holographic platform is configured for combining VR, AR and MR using, including but not limited to, holographic cameras, projectors and recorders for merging real and virtual worlds, physical and digital objects to co-exist and interact in real time.

The XR holographic platform is configured to include user activated modules that sort through repositories including but not limited to licenses, locations and preferences, sources user environment and analyzing all data to launch module presets.

### BRIEF DESCRIPTION OF THE DRAWINGS

FIG. 1 shows a block diagram of an overview of an XR holographic platform method and devices of one embodiment.

FIG. 2 shows a block diagram of an overview of combining VR, AR and MR of one embodiment.

FIG. 3 shows a block diagram of an overview of triggering holographic display of one embodiment.

FIG. 4 shows a block diagram of an overview of selecting and accessing custom drop down menus of one embodiment.

FIG. 5A shows for illustrative purposes only an example of menu selection tabbed windows of one embodiment.

FIG. 5B shows for illustrative purposes only an example of XR holographic screens of one embodiment.

FIG. 6A shows for illustrative purposes only an example of multiple XR holographic screens of one embodiment.

FIG. 6B shows for illustrative purposes only an example of open, move, nest, minimize and manipulate XR holographic screens of one embodiment.

FIG. 7A shows for illustrative purposes only an example of running all streaming and subscription software through the XR holographic platform of one embodiment.

FIG. 7B shows for illustrative purposes only an example of subscription software of one embodiment.

FIG. 8 shows a block diagram of an overview of network repository of one embodiment.

FIG. 9 shows a block diagram of subscription UI of one embodiment.

FIG. 10A shows for illustrative purposes only an example of register of one embodiment.

FIG. 10B shows for illustrative purposes only an example of log-in of one embodiment.

FIG. 10C shows for illustrative purposes only an example of profile of one embodiment.

FIG. 11 shows a block diagram of an overview of XR holographic platform delivery to the eye.

FIG. 12 shows a block diagram of an overview of relaying XR holographic platform data to output devices

FIG. 13 shows for illustrative purposes only an example of using hand gestures to access a virtual keyboard of one embodiment.

FIG. 14 shows for illustrative purposes only an example of eye movement manipulation of one embodiment.

FIG. 15 shows for illustrative purposes only an example of total VR immersion using VR headset of one embodiment.

FIG. 16 shows for illustrative purposes only an example of a using a cell phone to access AR advertising of one embodiment.

FIG. 17 shows for illustrative purposes only an example of MX manipulation of a paintbrush of one embodiment.

FIG. 18 shows for illustrative purposes only an example of XR automotive dash board integration of one embodiment.

FIG. 19 shows for illustrative purposes only an example of the advertising module for one embodiment.

FIG. 20 shows a block diagram of an overview of avatar creation of one embodiment.

FIG. 21 shows for illustrative purposes only the avatar elements of the fashion module for one embodiment.

FIG. 22 shows a block diagram of an overview of activating remote interaction of one embodiment.

FIG. 23A-B shows for illustrative purposes only elements of the educational module for one embodiment.

FIG. 24 shows for illustrative purposes only elements of the remote office module for one embodiment.

FIG. 25 shows a block diagram of an overview of triggering a dynamic environment of one embodiment.

FIG. 26A shows for illustrative purposes only an example of elements of an automotive module for one embodiment.

FIG. 26B shows for illustrative purposes only an example of automotive engineers remotely watching a crash test work product for one embodiment.

FIG. 27A shows for illustrative purposes only an example of elements of a military module of one embodiment.

FIG. 27B shows for illustrative purposes only an example of military usage of point cloud data of one embodiment.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### General Overview

It should be noted that the descriptions that follow, for example, in terms of an XR holographic platform method and devices is described for illustrative purposes and the underlying system can apply to any number and multiple types of output devices and graphic user interface devices. In one embodiment of the present invention, the XR holographic platform method and devices can be configured using AR. The XR holographic platform method and devices can be configured to include VR and can be configured to include MR using the present invention. The XR holographic platform method and devices provide freedom of movement, generated Virtual Objects have depth of field, and generated Virtual Objects look like actual objects in the user's reality.

COVID-19 Social Distancing:

The system and methods of holographic Extended Reality platform to layer virtual objects in real or augmented environments provides individuals and companies with greater options to gather virtually while avoiding close contact that would increase the exposure to each person to infection with COVID-19. The system and methods of holographic Extended Reality platform to layer virtual objects in real or augmented environments provides companies with real-time remote interaction from multiple physical and geographic areas where co-workers can personally interact, communicate and collaborate without the fear of COVID-19 infection. Each user interacting device is disinfected with an approved COVID-19 disinfectant prior to each use. COVID-19 travel restrictions have caused lost opportunities for personal collaboration reducing productivity and the benefits that come with joint sharing of ideas, thoughts and improvements in projects. The system and methods of holographic Extended Reality platform to layer virtual objects in real or augmented environments overcomes the travel restrictions and replaces actual travel with Extended Reality virtual travel adding to productivity while avoiding an increase of exposure to COVID-19 for those who would be traveling in potential “hot” spots and coming in contact with other populations that may not be adhering to protective measures of one embodiment.

### DETAILED DESCRIPTION

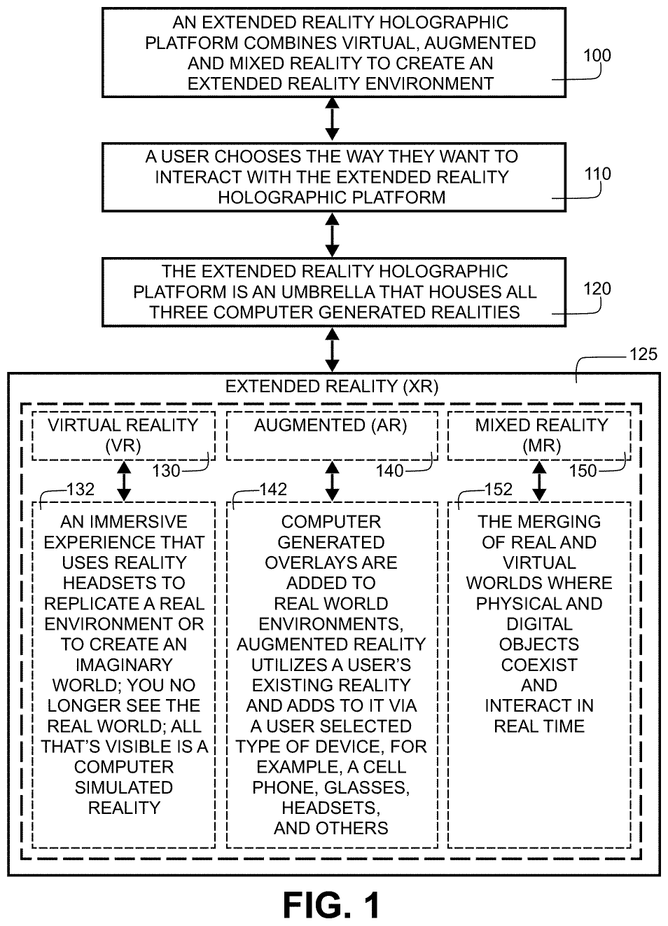

FIG. 1 shows a block diagram of an overview of an XR holographic platform method and devices of one embodiment. FIG. 1 shows an XR holographic platform combines VR, AR and MR to create an XR environment 100. A user chooses the way they want to interact with the XR holographic platform 110. The XR holographic platform is an umbrella that houses all three computer generated realities 120 within the XR environment 125.

VR 130 is an immersive experience that uses reality headsets to replicate a real environment or to create an imaginary world; you no longer see the real world; all that's visible is a computer-simulated reality 132.

AR 140 is computer generated overlays are added to real world environments, AR utilizes a user's existing reality and adds to it via a user selected type of device for example a cell phone, glasses, headsets, and others 142.

MR 150 is the merging of real and virtual worlds; physical and digital objects co-exist and interact in real time 152 of one or more embodiments.

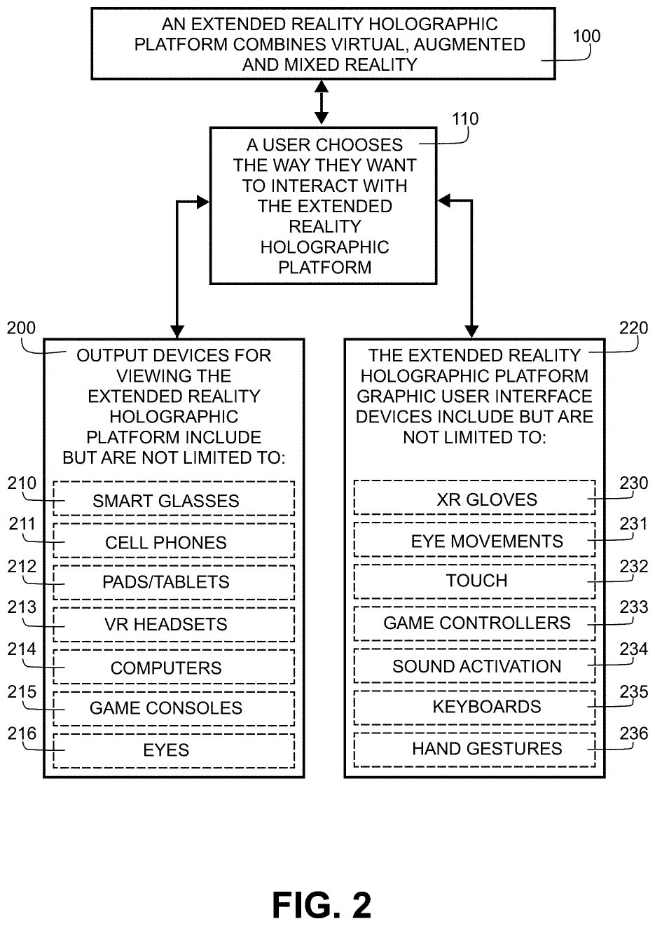

FIG. 2 shows a block diagram of an overview of combining VR, AR and MR of one embodiment. FIG. 2 shows an XR holographic platform combines VR, AR and MR 100. A user gets to choose the way they want to interact with the XR holographic platform 110. Output devices 200 for viewing the XR holographic platform include but are not limited to: smart glasses 210, cell phones 211, pads/tablets 212, VR headsets 213, computers 214, game consoles 215, and eyes 216. The XR holographic platform graphic user interface devices 200 include but are not limited to: XR gloves 230, eye movements 231, touches 232, game controllers 233, sound activation 234, a keyboard “S” key representing keyboards, real or virtual 235, and hand gestures 236 of one embodiment.

Menu Pulldown:

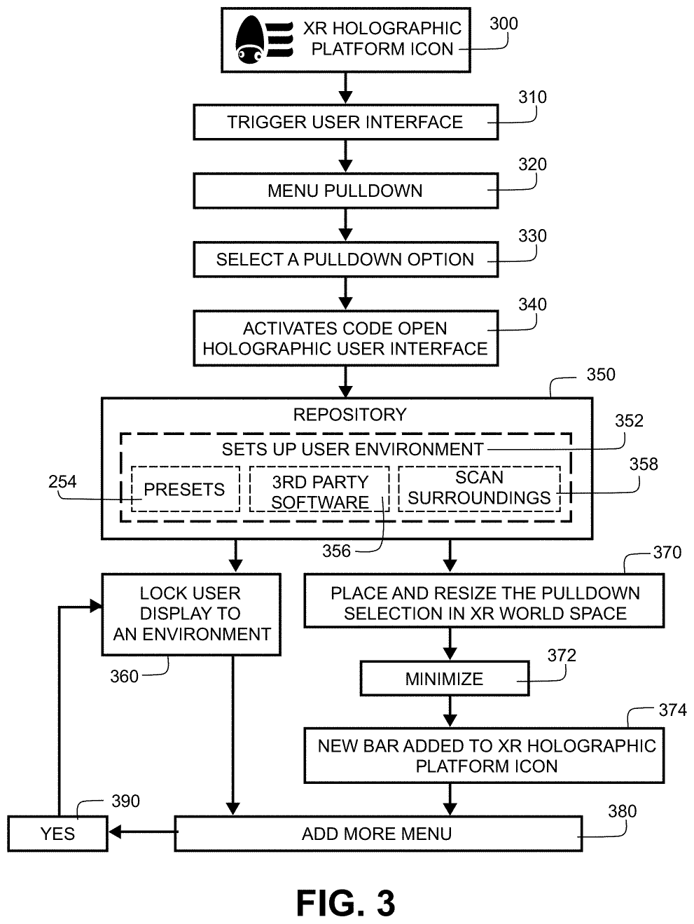

FIG. 3 shows a block diagram of an overview of menu pulldown of one embodiment. FIG. 3 shows an XR holographic platform icon 300. The XR holographic platform icon 300 triggers UI 310 for a menu pulldown 320. A user will select a pulldown option 330 that activates code to open a holographic user interface 340. The code will lock the holographic user interface 340 to repository 350. The activated code holographic user interface 340 will place and resize the pulldown selection in an XR user environment 352 and activate presets 254, check licenses for 3^{rd} party software 356, scan the user's surroundings 358 and lock the display to an environment 360. The user is able to place, resize 370 and minimize 372 the pulldown selection which will be represented as a new bar added to the XR holographic platform icon 374. The next steps ask the user if they want to add more menus 380. If the answer is yes 390 then the process returns to the menu pulldown 320 for a new selection by the user of one embodiment.

Menu Selections:

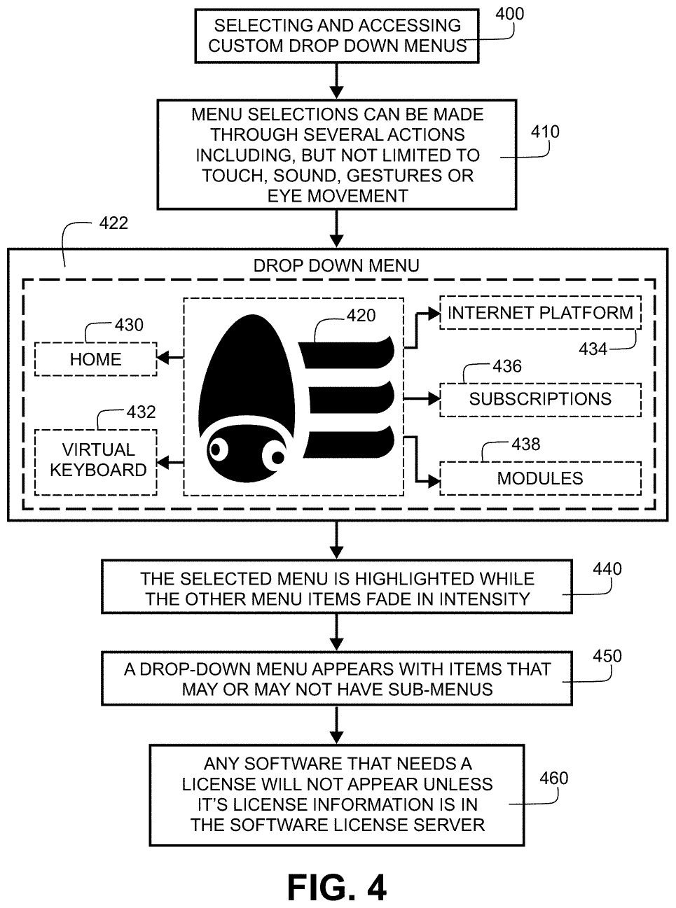

FIG. 4 shows a block diagram of an overview of XR menu selections through the holographic platform icon 420 of one embodiment. FIG. 4 shows selecting and accessing XR drop down menus 400. XR menu selections can be made through several actions including, but not limited to touch, sound, gestures or eye movement 410.

Drop down menu items 422 are accessed through the holographic platform icon 420. The head cap 430 takes the user back home. The face 432 launches a virtual keyboard. The top leg 434 opens an Internet platform that may or may not have favorite pages bookmarked. The middle leg 436 opens a drop down menu with the user's registered subscription software and streaming services/packages. The bottom leg 438 opens a drop down menu of the holographic platform's industry module presets that include defaults for remote office, education, advertising, fashion, automotive and military modules.

The selected menu is highlighted while the other menu items fade in intensity 440. Selecting a menu 410 is done using the holographic platform icon 420. A drop-down menu appears with items that may or may not have sub-menus 450. Any software that needs a license will not appear unless its license information is in the software license server 460 of one embodiment.

Menu Selection Tabbed Windows:

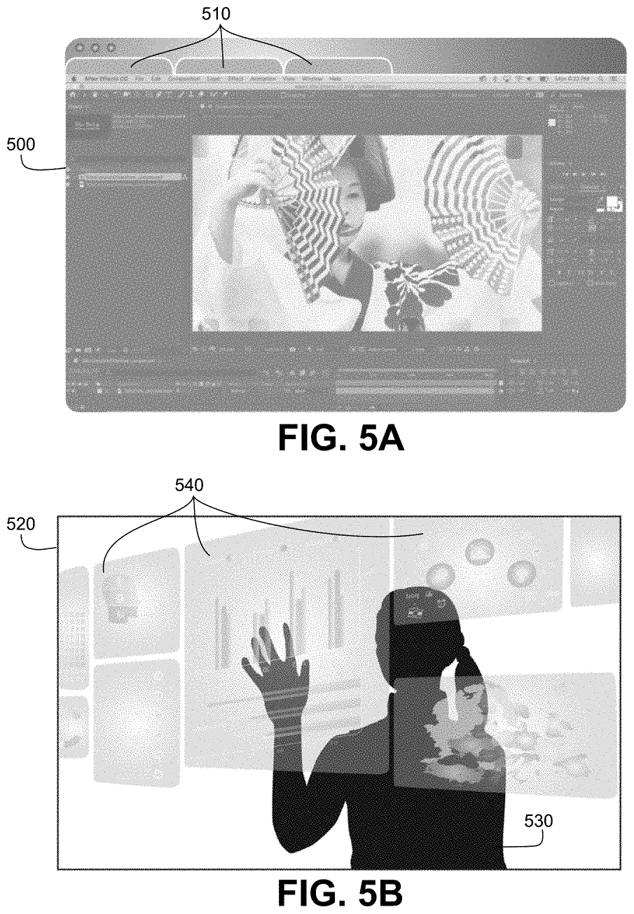

FIG. 5A shows for illustrative purposes only an example of menu selection tabbed windows of one embodiment. FIG. 5A shows an XR holographic menu screen 500 with menu selection tabs 510 of one embodiment.

XR Holographic Screens:

FIG. 5B shows for illustrative purposes only an example of XR holographic screens of one embodiment 520. FIG. 5B shows a user 530 and multiple XR holographic screens opened at the same time 540 of one embodiment.

Multiple XR Holographic Screens:

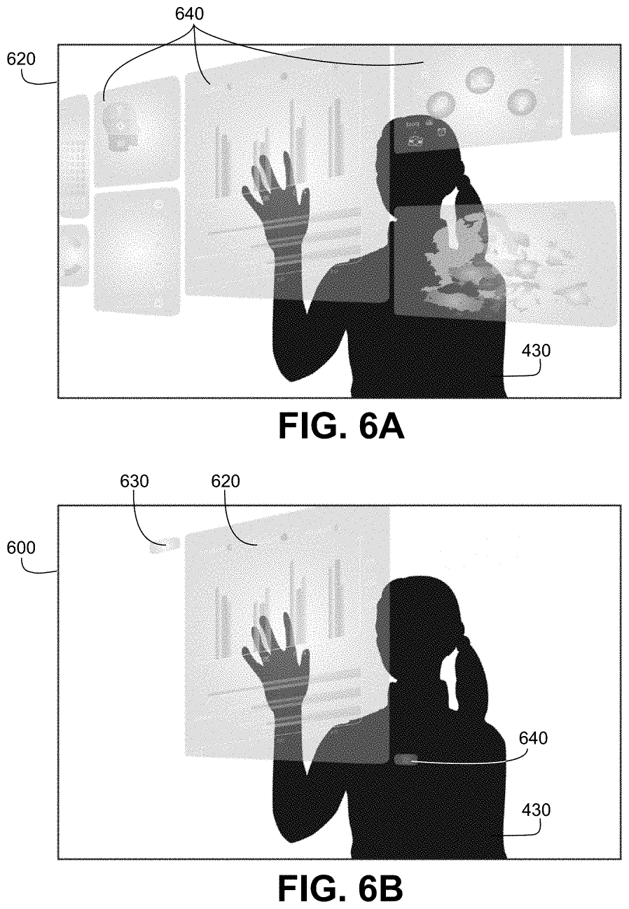

FIG. 6A shows for illustrative purposes only an example of multiple XR holographic screens of one embodiment 620. FIG. 6A shows a user 430 and multiple XR holographic screens opened at the same time 640 of one embodiment.

Open, Move, Nest, Minimize and Manipulate XR Holographic Screens:

FIG. 6B shows for illustrative purposes only an example of open, move, nest, minimize and manipulate XR holographic screens of one embodiment 600. FIG. 6B shows the user 430 with a user selected active holographic screen 620. FIG. 6B also shows minimized XR holographic screens 630 and 640 of one embodiment.

Running all Streaming and Subscription Software Through the XR Holographic Platform:

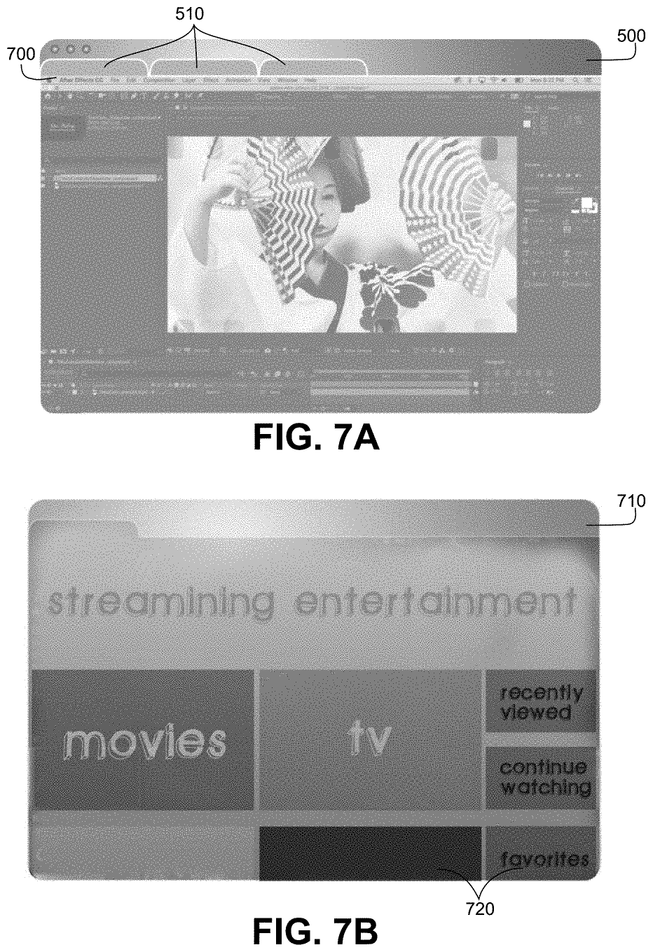

FIG. 7A shows for illustrative purposes only an example of running all streaming and subscription software through the XR holographic platform of one embodiment 500. FIG. 7A shows the XR holographic interface 700 of one embodiment for subscription production software. You can have multiple software packages open and running at the same time 510.

FIG. 7B shows for illustrative purposes only an example of subscription software of one embodiment. FIG. 7B shows a holographic subscription interface 710 and menu icons 720 for streaming subscription entertainment services of one embodiment.

Network Repository:

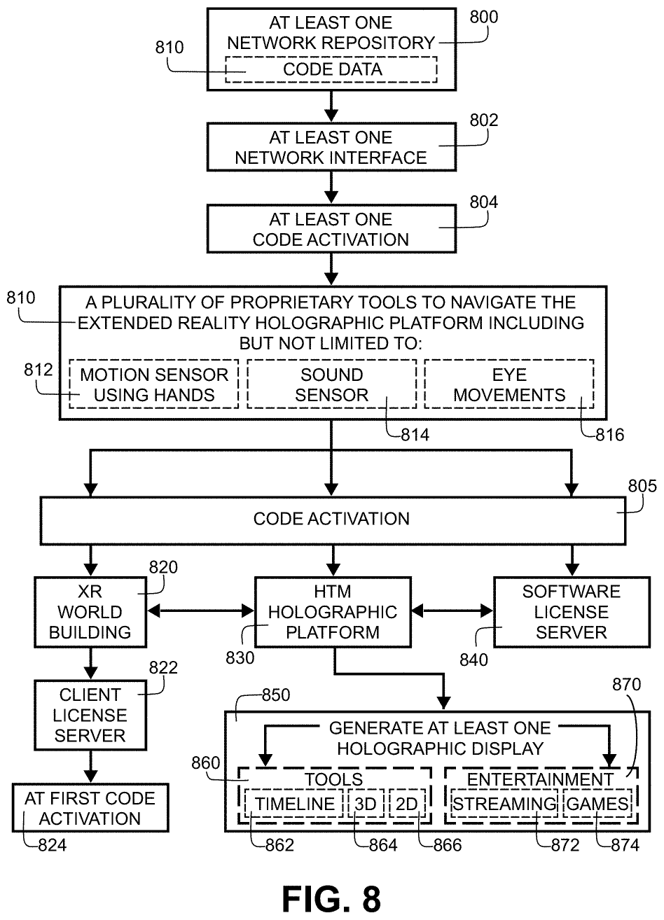

FIG. 8 shows a block diagram of an overview of network repository of one embodiment. FIG. 8 shows at least one network repository 800 containing recorded code data 801. The at least one network repository 800 is coupled to at least one network interface 802 used for at least one code activation 804. The at least one network repository 800 recorded code data is used for the at least one network interface 802 to activate a different function. The network interface 802 includes at least one proprietary tool to navigate the XR holographic platform 810 including but not limited to a motion sensor using hands 812, a sound sensor 814 and using eye movements 816 for the code activation 804. When a first code activation 805 is activated the XR holographic platform begins a process for XR world building 820. A client license server 822 will open XR world building 820 project activation 824.

A second code activation 805 activates an HTM holographic platform 830 used to activate at least one generated holographic display 850 with tools 860 including but not limited to a timeline 862, and objects including 3D 864 and 2D 866 objects. The HTM holographic platform 830 will also activate at least one generated user interface 850 for entertainment 870 including but not limited to streaming 872 and games 874.

A third code activation 707 activates a software license server 840 to check for licensed software to be run in the XR world building 820 of one embodiment.

Triggering of Subscription UI:1234

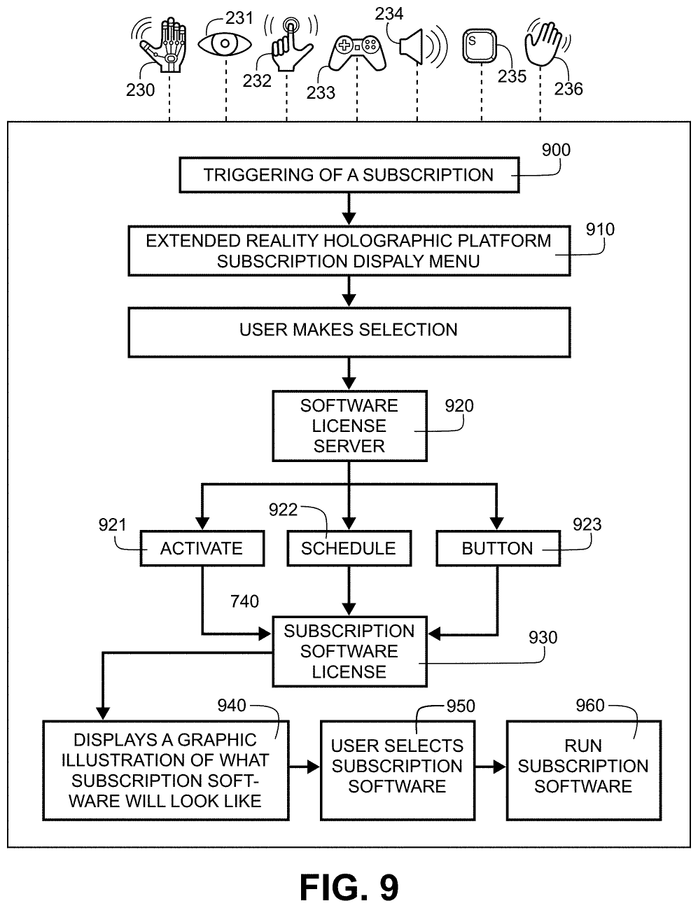

FIG. 9 shows a block diagram of subscription UI of one embodiment. FIG. 9 shows triggering of a subscription UI 900. The XR holographic platform has a subscription UI created 910. A user can trigger the subscription UI using an event, schedule, or button 920. Triggering an event 921 or schedule 922 or button 923 will open the software license server 740 where a subscription software license 930 is confirmed. The event, schedule, or button displays a graphic illustration of what subscription software will look like 940. The user selects subscription software 960 using a graphic user interface device 945 for triggering the software which can be but is not limited to XR gloves 230, eye movements 231, touches 232, game controllers 233, sound activation 234, a keyboard “S” key representing keyboards, real or virtual 235, and hand gestures 236.

Register:

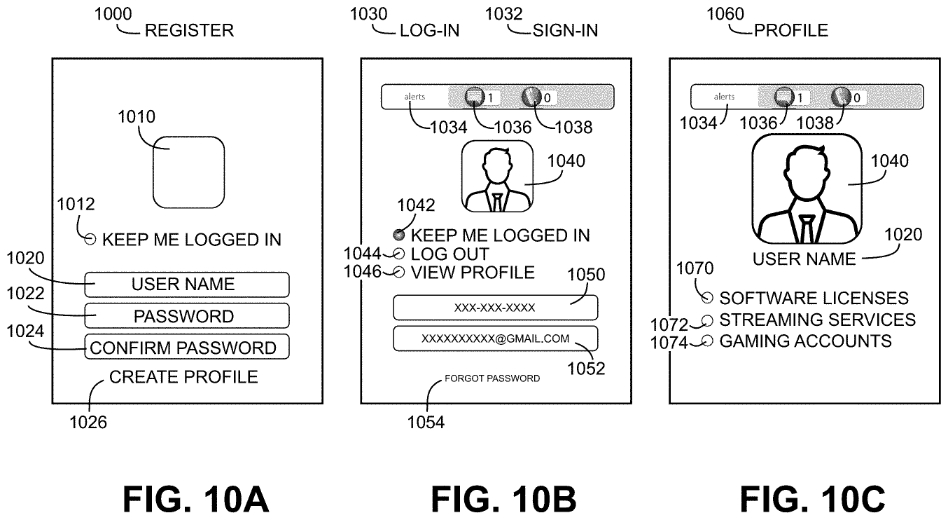

FIG. 10A shows for illustrative purposes only an example of register of one embodiment. FIG. 10A shows the steps to register 1000 a user. There is a user photo space 1010. A user may select to keep me logged in 1012. The user enters a user name 1020, and password 1022. The user then is asked to confirm password 1024 and create profile 1026 of one embodiment.

Log-in:

FIG. 10B shows for illustrative purposes only an example of log-in of one embodiment. FIG. 10B shows user can log-in 1030 with a password sign-in 1032. The sign-in page notifies the user of any alerts 1034 including text 1036 and phone 1038 alerts. The user will post a user photo 1040 and in this example click keep me logged in 1042. The sign-in page also shows where the user can log out 1044 and view profile 1046 for any additions or edits to the profile. The user enters the user phone number 1050 and email address 1052 of one embodiment.

Profile:

FIG. 10C shows for illustrative purposes only an example of profile of one embodiment. FIG. 10C shows a profile 1060 page that also notifies the user of any alerts 1034 including text 1036 and phone 1038 alerts. The user photo 1040 is showing along with the user name 1020. The user can stay current with a listing of software licenses 1070, streaming services 1072 and gaming accounts 1074 entered into their account of one embodiment.

Retinal Delivery:

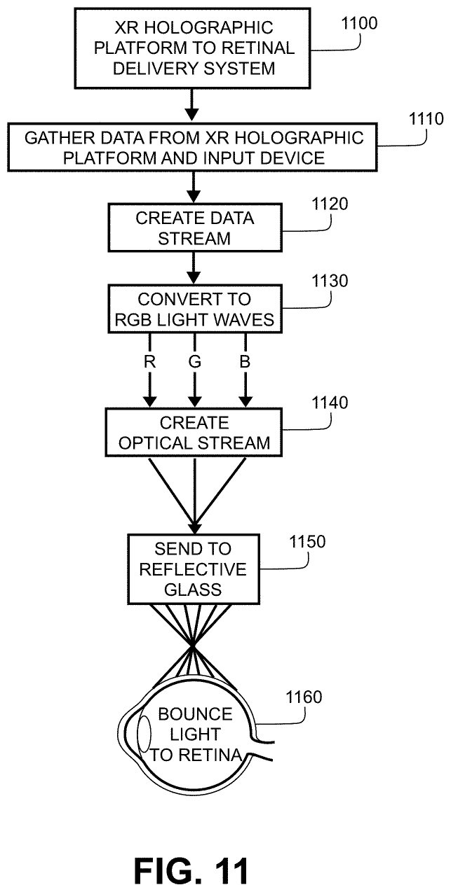

FIG. 11 shows a block diagram of an overview of XR holographic platform to retinal delivery system 1100. FIG. 11 shows gathering data from XR holographic platform and input device 1110, including but not limited to an XR glove 230, eye movement 231, touch 232, a game controller 233, a keyboard “S” key representing keyboards, real or virtual 235, and hand gestures 236, to create data stream 1120. The data stream is then converted into RGB light waves 1130 which creates an optical stream 1140 that is sent to reflective glass 1150 and then bounced to the user's retina 1160.

Device Delivery:

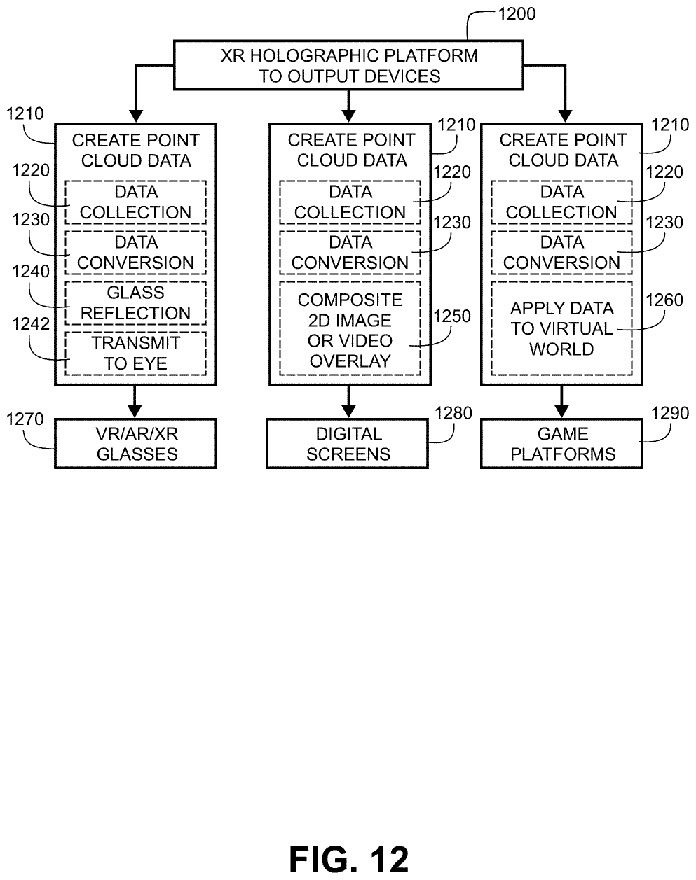

FIG. 12 shows a block diagram of an overview of relaying XR holographic platform data to output devices 1200. FIG. 12 shows XR holographic platform data bundled to create point cloud data 1210 that gets sent out to user devices.

VR/AR/MR glasses 1270, including but not limited to headsets, goggles, and glasses, receive point cloud data comprised of data collection 1220, data conversion 1230, glass reflection 1240 and transmittal to the eye 1242.

Digital screens 1280, including but not limited to cell phones, tablets, and computers, receive point cloud data comprised of data collection 1220, data conversion 1230, and composites of 2D image or video overlays 1250.

Game platforms 1290, including but not limited to consoles, receive point cloud data comprised of data collection 1220, data conversion 1230, and application of data to virtual worlds 1260.

Virtual Keyboard:

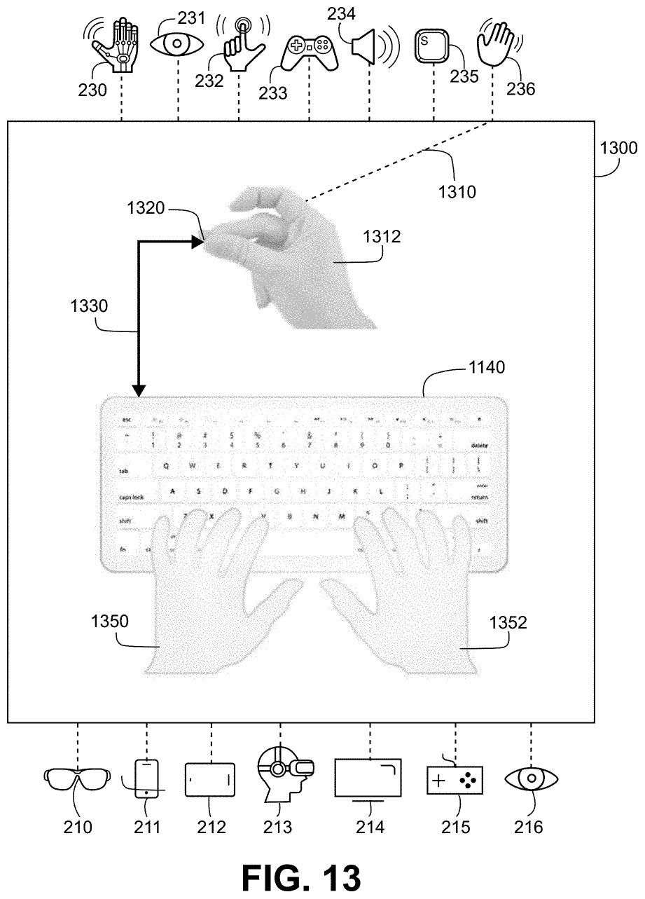

FIG. 13 shows for illustrative purposes only an example of virtual keyboard of one embodiment. FIG. 13 shows user interface devices include at least one from a group including an XR gloves 230, eye movements 231, touches 232, game controllers 233, sound activation 234, a keyboard “S” key representing keyboards, real or virtual 235, and hand gestures 236. In one embodiment 1300 the user 1312 selects a hand gesture 1310 as the input method and snaps his fingers 1320. The sound of snapping fingers causes a sound sensor to activate a holographic keyboard display 1330 along with a holographic left hand 1350 and a holographic right hand 1352 positioned to begin typing. Output devices for viewing the virtual keyboard 1240 include but are not limited to: 200 smart glasses 210, cell phone 211, pad/tablet 212, VR headsets 213, computer 214, game console 215, and eye 216 of one embodiment 1000. The user is ready to begin typing of a new embodiment.

Eye Movement Manipulation:

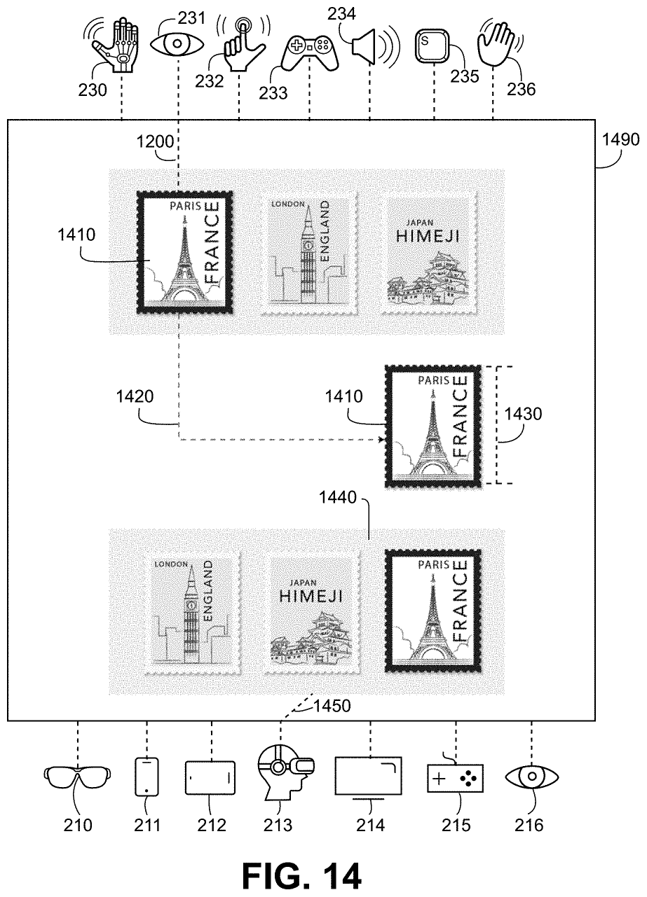

FIG. 14 shows for illustrative purposes only an example of eye movement manipulation of one embodiment 1490. FIG. 12 shows user interface devices including at least one from a group of an XR gloves 230, eye movements 231, touches 232, game controllers 233, sound activation 234, a keyboard “S” key representing keyboards, real or virtual 235, and hand gestures 236. In this example in the XR 1490 the user uses eye movement 231 to grab 1400 a stamp 1410.

The user using eye movement 231 on the grabbed postage stamp 1410 and repositions 1430 the stamp 1410 to a new position 1430. The postage stamp is set into new position with a blink of the eye movement 1430. The page of the stamp album is updated 1440 to display the new positioning. The user utilizes 1450 a VR headset 213 as the output device to view the virtual stamp album page embodiment. The output devices for viewing the XR holographic platform include but are not limited to: smart glasses 210, cell phone 211, pad/tablet 212, VR headsets 213, computer 214, game console 215, and eye 216 of one embodiment.

VR Immersion with Headset:

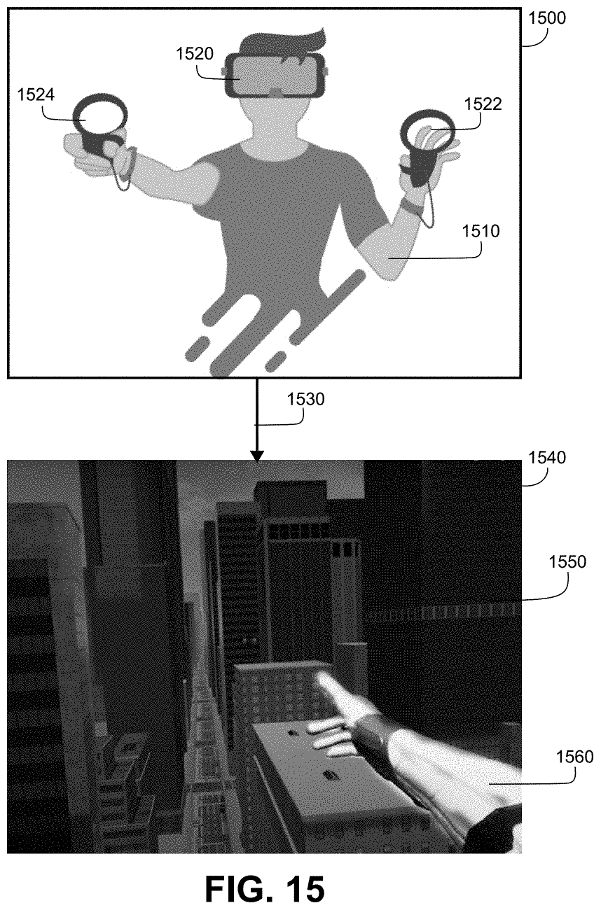

FIG. 15 shows for illustrative purposes only an example of total VR immersion 1050 using VR headset of one embodiment. FIG. 15 shows user 1510 wearing VR headset 1520 and holding right hand 1524 and left hand 1522 controllers in one embodiment 1500. The user 1510 enters 1530 the VR world 1540 can see his outstretched hand 15360 in one embodiment 1540.

AR Environmental Layering with a Cell Phone:

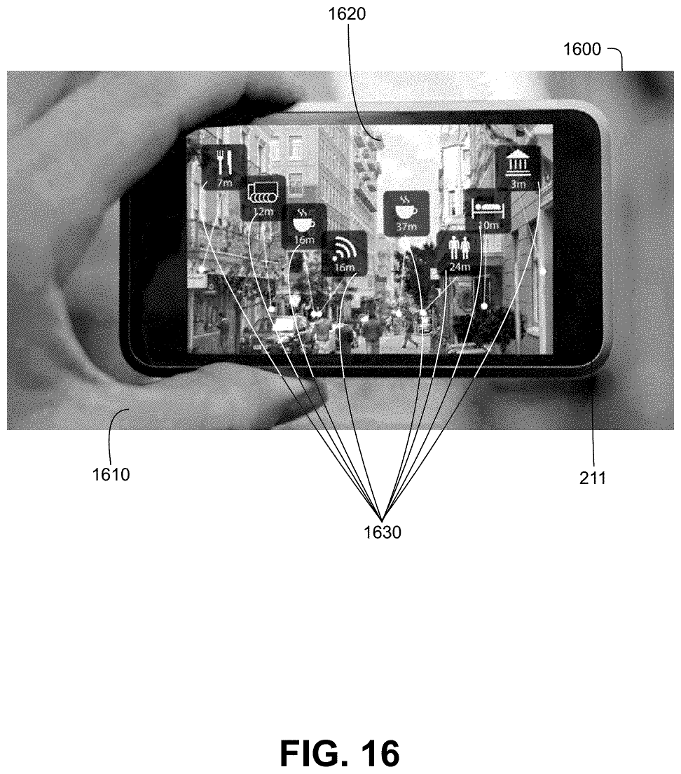

FIG. 16 shows for illustrative purposes only an example of total AR environmental layering 1600 of one embodiment. FIG. 16 shows user 1610 using a cell phone 211 to see what points of interest 1630 are in the vicinity of his location 1620. AR is the merging of real and virtual worlds; physical and digital objects co-exist of in one embodiment 1600.

MR Real Time Layering with Glove Manipulation:

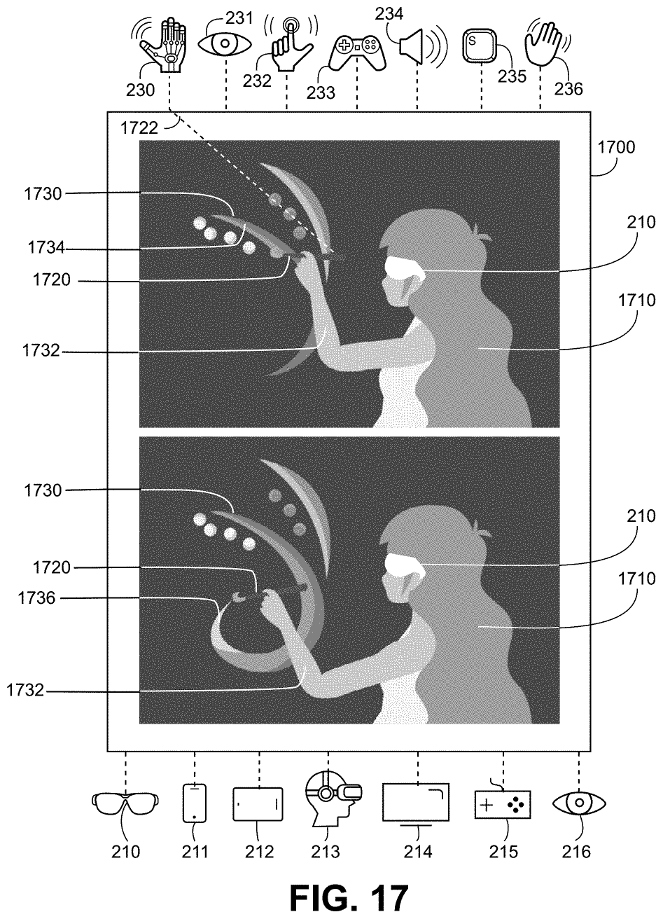

FIG. 17 shows for illustrative purposes only an example of user 1710 interacting with MR one embodiment 1700. FIG. 17 shows user interface devices including at least one from a group of an XR glove 230, eye movement 231, touch 232, a game controller 233, a keyboard “S” key representing keyboards, real or virtual 235, and hand gestures 236.

In this example user 1710 wearing XR glasses 210 creates virtual artwork 1730. An XR glove 230 enables 1722 user 1710 to hold MR paintbrush 1720 and paint 1732 stroke 1734. Stroke 1736 completes the virtual artwork 1730. MR merges real and virtual worlds; physical and digital objects co-exist and interact in real time of one embodiment 1700. The output devices for viewing the XR holographic platform include but are not limited to: smart glasses 210, cell phone 211, pad/tablet 212, VR headsets 213, computer 214, game console 215, and eye 216 of one embodiment.

XR Environmental Layering and Real Time Interaction:

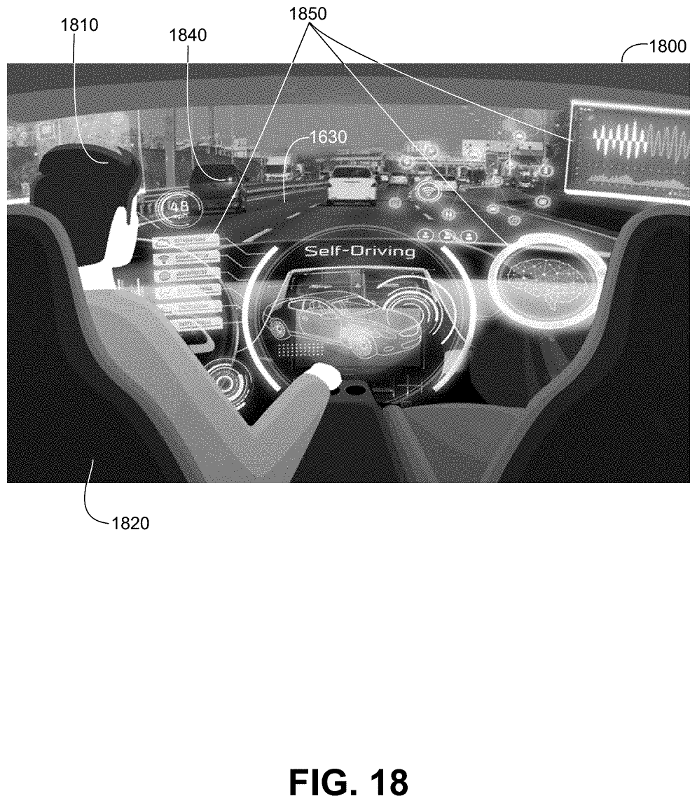

FIG. 18 shows for illustrative purposes only an example of user 1810 utilizing MR to drive a car 1820 of one embodiment 1800. FIG. 18 shows user 1810 driving a real car 1820 with a holographic dashboard 1850 on real roads 1830 navigating through real traffic 1840. Real and virtual worlds are seamlessly merged as physical and digital objects co-exist and interact in real time in one embodiment 1800.

Marketing Module:

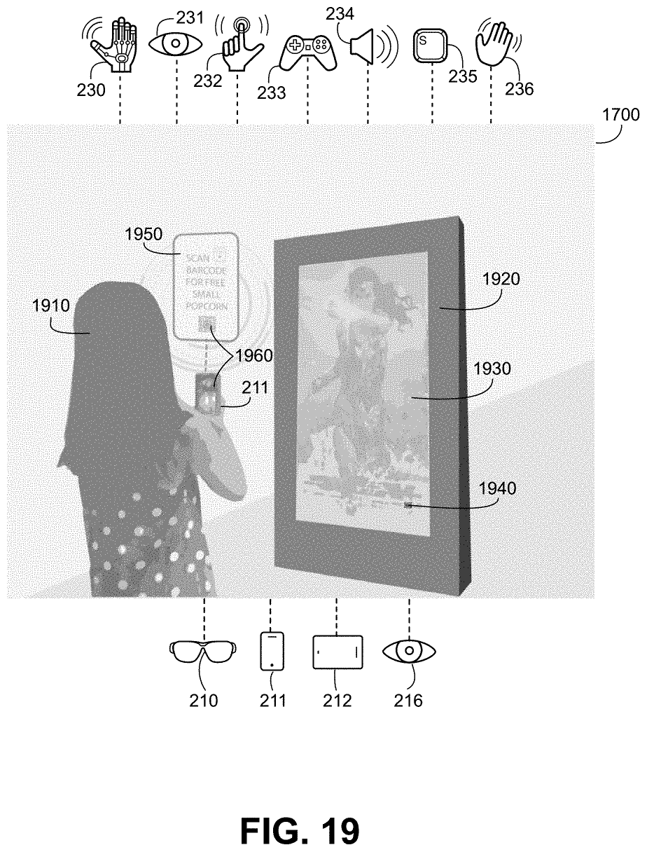

FIG. 19 shows for illustrative purposes only an example of user 1910 accessing a VOB ad using her cell phone 211. FIG. 19 shows user input triggers including at least one from a group of an XR gloves 230, eye movements 231, touches 232, game controllers 233, sound activation 234, a keyboard “S” key representing keyboards, real or virtual 235, and hand gestures 236. In this example the user 1910, present in the real world 1900, approaches an outdoor with an advert 1920 housing an upcoming movie poster 1930.

The movie poster 1930 contains a scan code 1940 that can be accessed by methods including but are not limited to XR glasses 210, cell phone 211, pad/tablet 212, eyes 216 and hand gestures 236. The user 1910 uses her cell phone 211 to access the scan code 1940. VOB 1950 appears with an enticement for user 1910 to see the movie, a barcode 1960 that is downloaded to cell phone 211 for the user 1910 to redeem at the theater. This is only one of many ways the marketing module provides a specific set of tools to give brands new immersive ways for consumers to interact with products. Output devices for viewing the XR holographic platform can include but are not limited to: smart glasses 210, cell phone 211, pad/tablet 212, and eye 216 of one embodiment.

Avatar Creation:

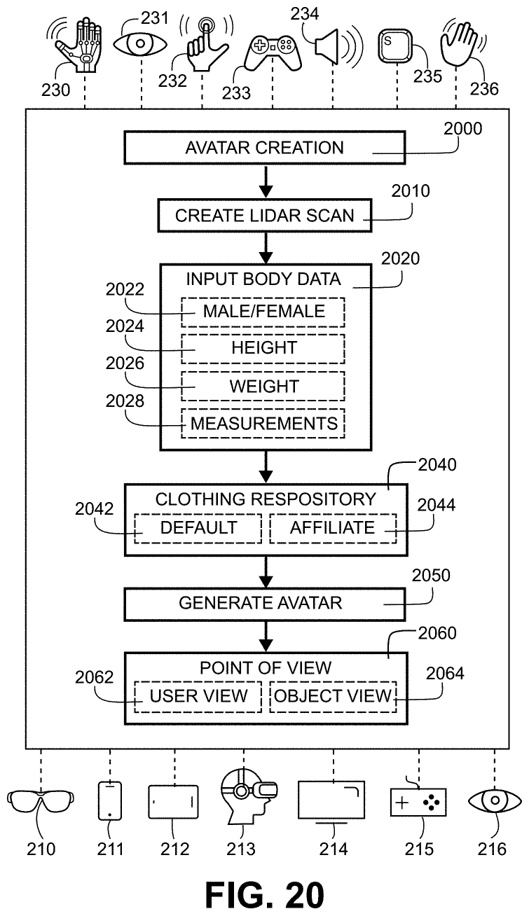

FIG. 20 shows a block diagram of an overview of avatar creation of one embodiment. FIG. 20 shows avatar creation 2000 occurring when the user scans 2010 him/herself using LIDAR technology 2010. User triggers input using devices including but not limited to XR gloves 230, eye movements 231, touches 232, game controllers 233, sound activation 234, a keyboard “S” key representing keyboards, real or virtual 235, and hand gestures 236. User inputs body data 2020 that can include but is not limited to male/female 2022, height 2024, weight 2026, and measurements 2028. User selects clothing from a clothing repository 2040 containing default 2042 and affiliate 2044 libraries. Once all input is entered the avatar is generated 1850. User selects a point of view 2060 of either user view 2062 or object view 2064. User selects one of the following devices including but not limited to: smart glasses 210, cell phone 211, pad/tablet 212, VR headsets 213, computer 214, game console 215, and eye 216 to see the avatar of one embodiment.

Fashion Module:

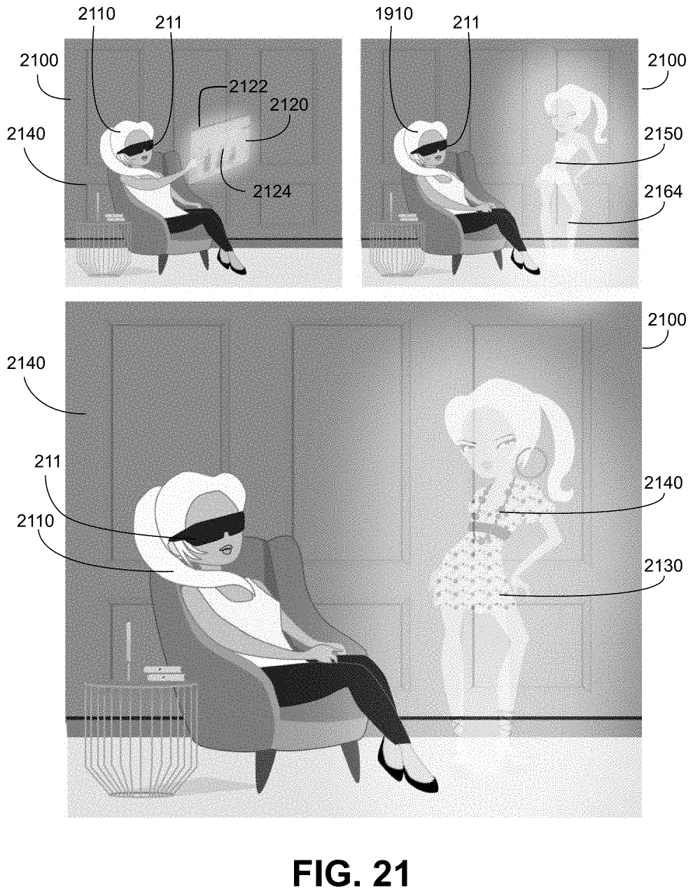

FIG. 21 shows for illustrative purposes only the avatar elements of the fashion module for one embodiment. FIG. 21 shows user 2110 at home 2140 wearing MX glasses 211, using the XR holographic platform 2120, to surf the Internet 2122 for a new outfit 2124. User 2110 generates her avatar 2150, opts to view it in object view 2164, selects a pose or series of poses from the object view preset and clothes 2140 her avatar in her shopping selects 2130. Physical and digital objects co-exist and interact in real time of one embodiment 2100.

This is only one of many ways the marketing module provides a specific set of tools to service the fashion industries. Other tools include but are not limited to virtual stores and fashion shows. Output devices for viewing the XR holographic platform can include but are not limited to: smart glasses 210, cell phone 211, pad/tablet 212, and eye 216 of one embodiment.

Remote Interaction Activation:

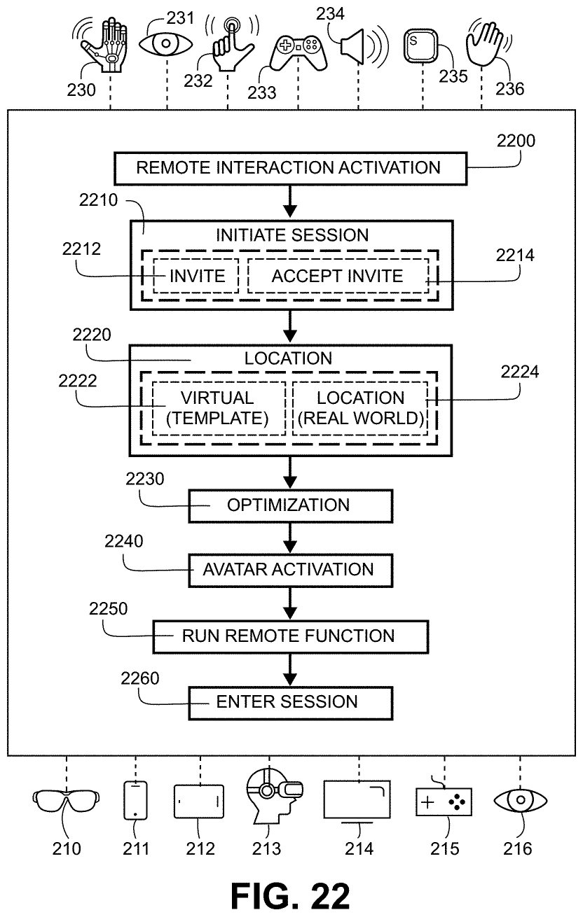

FIG. 22 shows for illustrative purposes a block diagram of an overview of remote interaction activation of one embodiment. FIG. 22 shows user interface devices including at least one from a group of XR gloves 230, eye movements 231, touches 232, game controllers 233, sound activation 234, a keyboard “S” key representing keyboards, real or virtual 235, and hand gestures 236.

Remote interaction activation 2200 occurs when a session is initiated 2210 and the user either invites 2212 participants or accepts an invitation 2214. Whoever initiates the session determines the session location 2220, virtual space 2222 or the real world 2224. The location 2220 is optimized 2230 and user avatar 2240 activated. The run remote function 2250 enters user avatar into the session 2260. Output devices for viewing the XR holographic platform include but are not limited to: 200 smart glasses 210, cell phone 211, pad/tablet 212, VR headsets 213, computer 214, game console 215, and eye 216 of one embodiment.

Educational Module:

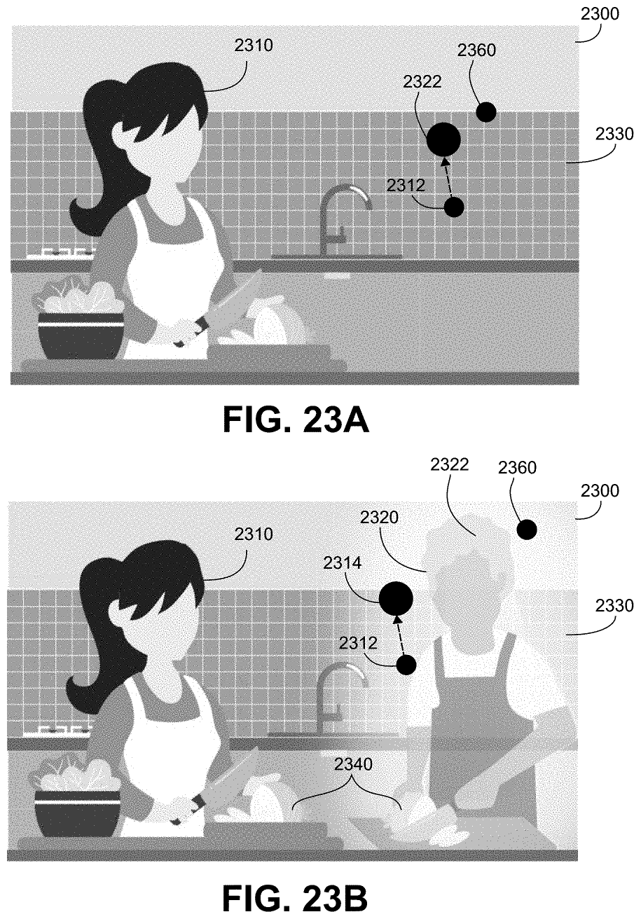

FIG. 23A shows for illustrative purposes only an example of remote learning. FIG. 21A shows user 1 2310 inviting 2312 user 2 2322 to join a remote session 2360 in her real world kitchen 2330 in one embodiment 2300.

FIG. 23B shows for illustrative purposes only an example of user 2's avatar 2120 joining user 1 2310 in her kitchen. FIG. 23B shows user 2 2322 accepting 2314 remote invitation 2312 and sending his avatar 2320 to her kitchen 2330 to instruct her on cooking techniques 2340 of one embodiment 2300.

Additional examples include Teaching and Education Explain abstract and difficult concepts, with student engagement and interaction. Instructors can provide remote training. Lessons can have an unlimited number of participants and users access to instruction that heretofore would have been geographically impossible. The user is able to walk 360° around the instructor for more immersive, interactive tutorials.

A highly detailed holographic rendering of the teacher/instructor's likeness can be displayed in formats including a “still”, a real-time animated image, or a 3D Virtual Object matching the movements and gestures of the teacher/instructor. The production, capture and projection of the teacher/instructor and their work product can be produced in AR, VR, MR or XR of one embodiment.

Remote Office Module:

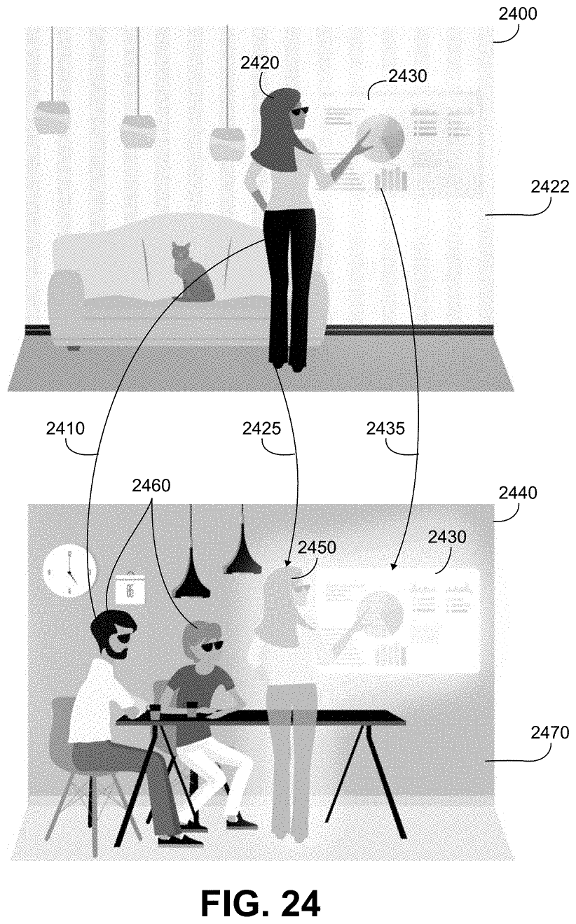

FIG. 24 shows for illustrative purposes only an example of a remote worker 2420 at Location A 2400 interacting with co-workers at a Location B 2440 of one embodiment. FIG. 24 shows a remote worker 2420 working away from the main office 2440. The remote worker 2420, for example, is working from home. At home, the remote worker 2420 wears smart glasses 210 to access the XR platform to create work product 2230 of one embodiment.

The remote worker's colleagues 2460 invite her 2410 to a remote session 2470 in the main office workroom 2440. A highly detailed avatar 2450 of the remote worker 2420 as well as her holographic work product 2430 are transmitted 2415 and 2435 to the main office work room 2440 where the remote worker's colleagues 2460 are gathered for a product review. The remote worker's colleagues 2460 also wear smart glasses 210 to enable them to see the remote worker's avatar 2450 and the remote worker's holographic work product. Both the remote worker's avatar 2450 and her colleagues 2260 are able to interact and communicate in real time. The remote worker 2410 can change or update her holographic work product 2430 based upon her colleagues' 2460 comments and input just as though the remote worker 2420 was present in the conference room as one embodiment.

In another embodiment the remote worker 2420 is able to send her open avatar 2450 and holographic work product 2430 to multiple locations simultaneously and discuss her work product with others in distant locations worldwide.

For multiple remote workers, the main office department manager is able to see through the bidirectional XR holographic platform that remote workers are actually working at their remote offices and be able to interact with the remote worker's open holographic selves as if they were all in the same environment in one embodiment.

The XR holographic platform method and devices could, but don't need to include, holographic video cameras. The holographic video cameras capture a worker's work product in a format consistent with the work product format including a multi-sided documents, one or more 3D object, a holographic video, and a bound multi-page report. For example an office can use an XR holographic platform recorder to capture the remote worker's presentation and follow-up Q&A for later viewing by those who could not attend the presentation.

Dynamic Environment:

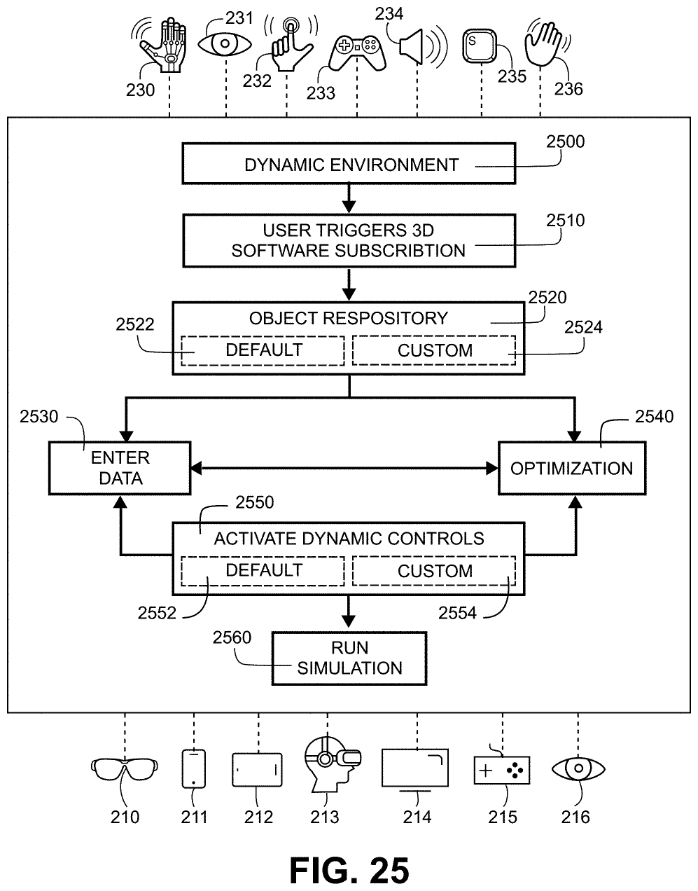

FIG. 25 shows for illustrative purposes a block diagram of an overview of a dynamic environment of one embodiment 2500. FIG. 25 shows user interface devices including at least one from a group of XR gloves 230, eye movements 231, touches 232, game controllers 233, sound activation 234, a keyboard “S” key representing keyboards, real or virtual 235, and hand gestures 236.

Dynamic environment 2500 is activated when user triggers 3D software subscription 2510. User selects default 2522 or custom 2524 from the object repository 2510. The user enters data 2530, which can include but is not limited to speed, environmental factors and visibility, then optimizes 2540 data and objects. The user then activates dynamic controls 2550 and selects default 2552 or custom 2554, which can include but is not limited damp, drag, wind, gravity, etc. Output devices for viewing the XR holographic platform include but are not limited to: 200 smart glasses 210, cell phone 211, pad/tablet 212, VR headsets 213, computer 214, game console 215, and eye 216 of one embodiment.

Automotive Module:

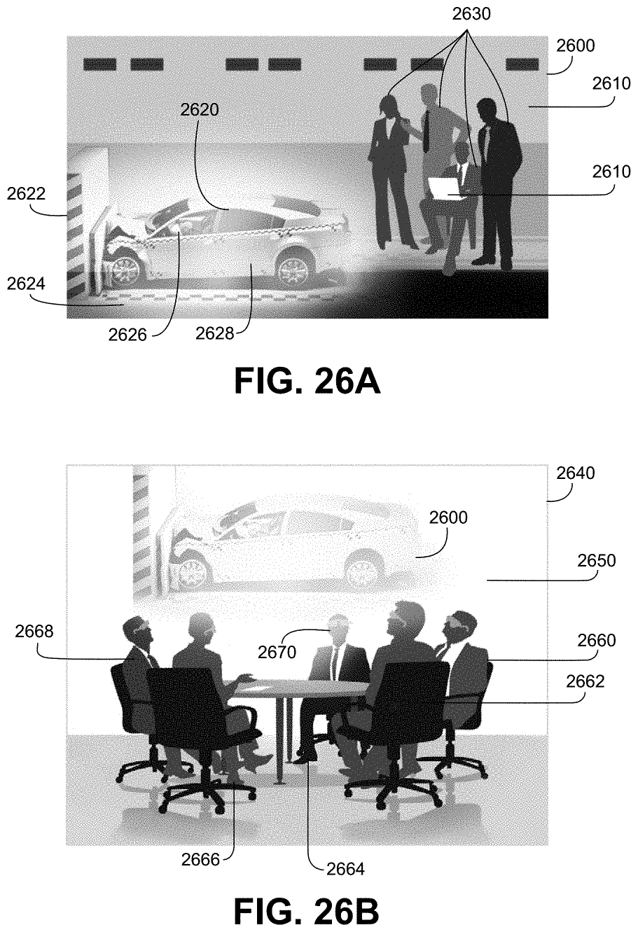

FIG. 26A shows for illustrative purposes automotive engineers 2630 utilizing automotive module presets to run holographic crash test dummy simulations 2620. FIG. 26A shows a group of automotive engineers 2630 in an empty warehouse 2610. They use the XR holographic platform 2610 to create a three dimensional photorealistic car 2628 containing a crash test dummy 2626, driving on a holographic racetrack 2624, running into a holographic wall 2622. By using the automotive module, they are able to include dynamic properties in their simulation 2620, run multiple tests with varying parameters and never wreck an actual car, merge real and virtual worlds; physical and digital objects co-exist and interact in real time of one embodiment 2600.

FIG. 26B shows for illustrative purposes automotive engineers 2660-2670 remotely watching the work product 2600 of the engineers 2630. FIG. 26B shows automotive executives 2660-2670 viewing the holographic crash test simulations 2600 in their corporate office 2650 in one embodiment 2640.

These are just a few examples of how the automotive module provides a specific set of tools to service the auto industry. Other uses include but are not limited to design and development, integrated holographic dashboards and material durability testing. Output devices for viewing the XR holographic platform can include but are not limited to: smart glasses 210, cell phone 211, pad/tablet 212, and eye 216 of one embodiment.

Military Module:

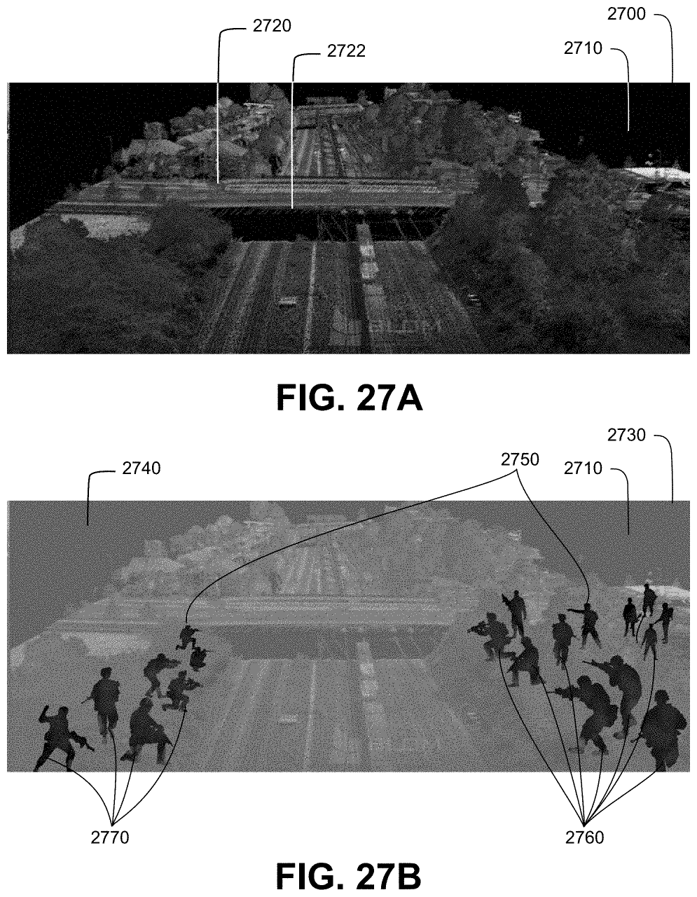

FIG. 27A shows for illustrative purposes potential usage of the military module. FIG. 27A shows a LIDAR scan 2710 of terrain 2720 proposed for a military action 2722 in one embodiment 2700.

FIG. 27B shows for illustrative purposes military usage of point cloud data 2540. FIG. 27B shows a point cloud data 2740 used in combination with LIDAR scanning 2710 to reveal hidden enemy fighters 2760 and 2770 in one embodiment 2730.

More examples in the military module include Aerospace and Defense: Less costly and safer training environments. The XR holographic platform provides real-time targeting and enhanced mission planning. From medical to mechanical, expert guidance is immediately available to the battlefield.

Other examples of user's interaction with the XR holographic platform include Entertainment in home: A user's favorite TV and movie characters walk out of the TV and into the user's living room. Users can enjoy “Live” concerts. Users can stream games in virtual surroundings. Entertainment destination: Users can experience next level Escapes Rooms utilizing XR to switch out graphics with artificial intelligence, to match game solving abilities. Holographic themed movie sets and sports rooms provide users with the experience of being in their favorite movie or participating in the major leagues.

Development and Manufacturing: Less down time and better feedback for city planning, construction, manufacturing, packaging, displays and automotive. Advertising and Marketing: Gives brands new immersive ways for consumers to interact with products. Cars, clothes, furniture can be replicated to scale anywhere, at any time. Ads can stream outside of devices of other embodiments.

The foregoing has described the principles, embodiments and modes of operation of the present invention. However, the invention should not be construed as being limited to the particular embodiments discussed. The above-described embodiments should be regarded as illustrative rather than restrictive, and it should be appreciated that workers may make variations in those embodiments skilled in the art without departing from the scope of the present invention as defined by the following claims.

What is claimed is:

1. A method, comprising:
Creating an XR holographic platform configured for combining VR, AR and MR;
Choosing the way a user interacts with the XR holographic platform;
Using reality headsets to replicate a real environment to create an immersive experience and a computer simulated reality;
Creating at least one user open hologram and at least one user work product holographic screen;
Generating computer overlays for adding to real world environments using a user selected type of device from a group including a cell phone, glasses, headsets, and others; and using holographic cameras, projectors and recorders for merging of real and virtual worlds, physical and digital objects configured to co-exist and interact in real time.

2. The method of claim 1, wherein the remote worker user open hologram is a highly detailed holographic rendering of the remote worker's likeness.

3. The method of claim 1, further comprising creating at least one remote worker user open hologram in formats including a “still” and a real-time animated image matching the movements and gestures of the remote worker.

4. The method of claim 1, further comprising generating computer overlays including a user holographic work product on at least one holographic screen.

5. The method of claim 1, further comprising creating at least one user work product holographic screen configured to be minimized and maximized.

6. The method of claim 1, further comprising transmitting and projecting the at least one user open hologram and at least one user work product holographic screen at distant locations worldwide.

7. The method of claim 1, further comprising the XR holographic platform is configured for viewing using output devices from a group but are not limited to AR glasses, cell phone, pad/tablet, VR glasses, computer, game console, and eye.

8. The method of claim 1, further comprising interfacing by a user with the XR holographic platform using user interface devices chosen from a group but are not limited to an XR glove, eye movement, touch, game controller, keyboards, real or virtual, and hand gestures and each user interacting device is disinfected with an approved COVID-19 disinfectant prior to each use.

9. The method of claim 1, further comprising typing on the at least one user work product holographic screen using a virtual keyboard.

10. The method of claim 1, further comprising running on the XR holographic platform subscription software in a user chosen reality from the group of VR, AR and MR.

11. An apparatus, comprising:
A computer configured for combining VR, AR and MR to form an XR holographic platform;
At least one digital device for capturing holographic images in real-time and in VR, AR and MR;
At least one digital device for projecting holographic images in real-time and in VR, AR and MR;
At least one digital device for transmitting and receiving holographic images in real-time and in VR, AR and MR;
At least one output device for viewing the XR holographic platform; and
At least one graphic user interface device configured for interacting with the XR holographic platform.

12. The apparatus of claim 11, further comprising output devices from a group but are not limited to AR glasses, cell phone, pad/tablet, VR glasses, computer, game console, and eye for viewing the XR holographic platform.

13. The apparatus of claim 11, further comprising using interface devices from a group but are not limited to an XR glove, eye movement, touch, game controller, echo devices, keyboards, real or virtual 235, and hand gestures and each user interacting device is disinfected with an approved COVID-19 disinfectant prior to each use.

14. The apparatus of claim 11, further comprising at least one digital device for projecting holographic images including a remote worker user open hologram and the remote worker user's holographic work product.

15. The apparatus of claim 11, further comprising at least one digital device for capturing holographic images including a highly detailed holographic rendering of the remote worker's likeness to create a remote worker user open hologram.

16. An apparatus, comprising:
A digital device configured for generating three computer generated realities to form an XR holographic platform;
At least one digital device configured to capture, transmit, project, and record holographic images in real-time and in at least one of the three computer generated realities; wherein the holographic images using the at least one digital device is transmitted to distant locations worldwide and projected for viewing by others at the distant locations; and
at least one digital device used by a user for viewing and interacting with the XR holographic platform.

17. The apparatus of claim 16, further comprising using the at least one digital device configured to capture, transmit, project, and record holographic images to create a highly detailed holographic rendering of a remote worker's likeness to create a remote worker user open hologram.

18. The apparatus of claim 16, wherein the at least one digital device for a user viewing the XR holographic platform includes output devices from a group but are not limited to AR glasses, cell phone, pad/tablet, VR glasses, computer, game console, and eye and each user interacting device is disinfected with an approved COVID-19 disinfectant prior to each use.

19. The apparatus of claim 16, wherein the at least one digital device for a user interacting with the XR holographic platform includes user interface devices from a group but are not limited to an XR glove, eye movement, touch, game controller, echo devices, keyboards, real or virtual, and hand gestures.

20. The apparatus of claim 16, further comprising using the at least one digital device for interacting with the XR holographic platform to create holographic images to form holographic screens for a user to create a work product.
